(19) United States
(12) Patent Application Publication
(10) Pub. No.: US 2025/0374110 A1
(43) Pub. Date: Dec. 4, 2025

(54) Adaptive Communication of Data Subject to Latency Requirement

(71) Applicant: Telefonaktiebolaget LM Ericsson (publ), Stockholm (SE)

(72) Inventors: Charlie Pettersson, Solna (SE); Abhishek Ambede, Malmö (SE); Leif Wilhelmsson, Lund (SE); Rocco Di Taranto, Lund (SE); Dennis Sundman, Sollentuna (SE)

(21) Appl. No.: 18/873,560

(22) PCT Filed: Jul. 8, 2022
(86) PCT No.: PCT/EP2022/069116

§ 371 Date: Dec. 10, 2024

(51) Int. Cl. H04W 28/02; H04W 72/512

(52) U.S. Cl. CPC H04W 28/0236; H04W 72/512

(57) ABSTRACT

A wireless communication device (10, 11) sends a first wireless transmission during communication of data subject to a latency requirement. The first wireless transmission indicates a change of a need to communicate the data and comprises information on the data to be communicated. In response to sending the first wireless transmission, the wireless communication device (10, 11) further communicates the data in a second wireless transmission.

### TECHNICAL FIELD

The present invention relates to methods for controlling wireless transmissions and to corresponding devices, systems, and computer programs.

### BACKGROUND

Wireless communication technologies may use licensed frequency bands and/or license-exempt frequency bands. A typical example of a wireless communication technology operating in license-exempt frequency bands is the WLAN (Wireless Local Area Network) technology, also referred to as “Wi-Fi”, according to “IEEE Standard for Information Technology—Telecommunications and Information Exchange between Systems-Local and Metropolitan Area Networks—Specific Requirements-Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 Standard”.

Due to the recent large availability of license-exempt spectrum in the 6 GHz frequency band, there is an ever-increasing interest in low/bounded latency wireless communications in this spectrum to support, for example, applications in Industrial Internet of Things (IIoT) and gaming. One requirement in such applications is that a packet should be transmitted “at the right time”, i.e., without an excessive amount of unpredictable delay or latency. Accordingly, a transmitter should preferably be able to access the wireless channel with a latency whose variation around a mean value is bounded. This variation around the mean value is also denoted as jitter.

To meet such requirements of controlled or bounded latency, in the following also denoted as “low latency”, retransmissions may need to be avoided. Accordingly, a further important requirement is high reliability, i.e., that packets are correctly received with high probability. A still further requirement may be that the receiver processes the received data as soon as possible to deliver the processed data to the higher layers.

The IEEE 802.11 Standard has typically not been developed with an emphasis on achieving low latency communications with high reliability. This can be, at least in part, attributed to the random nature of the channel access in the license-exempt spectrum. The nature of the channel access rules and the regulations for license-exempt spectrum typically have the effect that it is not possible to provide deterministic channel access opportunities for the transmitting stations (STAs), unless the WLAN devices operate in a contention free mode, for example using a orthogonal frequency division multiple access (OFDMA) scheduled mode, and in a completely controlled environment, typically in absence of any interference. More specifically, to access a channel while operating in license-exempt spectrum, a STA must typically first perform measurements on the channel and determine whether the channel is idle or busy. If the channel is busy, the STA is not allowed to access the channel but shall instead defer from transmission. On the other hand, if the channel is idle, the STA must first back off for a randomly determined backoff time. The random backoff time has the purpose of reducing the risk of collision since multiple STAs may attempt to access the channel and transmit at the same time. In addition, when operating in license-exempt spectrum, the channel conditions experienced by the receiving STA may be rather unpredictable. This implies that even if the transmitting STA will be able to transmit a packet as desired, the receiving STA might not be able to decode it. This is an inherent problem for many systems that are based on listen before talk (LBT) mechanisms, as it is the transmitting device that determines whether to transmit or not, which is typically done without any, or very limited, knowledge about the conditions at the receiving device. Such problems make it challenging to support applications that require high reliability and low latency in license-exempt spectrum.

An enhancement of the WLAN technology referred to as EHT (Extremely High Throughput), to be introduced with an amendment denoted as IEEE 802.11be, is planned to be certified as Wi-Fi 7. The EHT technology is for example described in IEEE draft “IEEE P802.11be/D2.0”, May 2022, in the following denoted as EHT draft. The EHT draft also includes a feature for low latency, denoted as restricted Target Wake Time (rTWT). In this feature, an rTWT service period is a restricted period of time during which only certain STAs with critical traffic can transmit or receive. A further feature included in the EHT draft is multi-link (ML). In ML, a device termed as a multi-link device (MLD) has multiple affiliated STAs, each of which can communicate using independent wireless channels, also referred to as links. Communication over multiple links by an MLD is termed as multi-link operation (MLO). For example, an MLD can have two affiliated STAs, one communicating using a channel in the 5 GHz frequency band and the other communicating using a channel in the 6 GHz frequency band. Alternatively, as another example, an MLD can have two affiliated STAs, each communicating using channels in the 6 GHz frequency band. An AP MLD means an MLD with two or more affiliated AP STAs. A non-AP MLD corresponds to an MLD with two or more affiliated non-AP STAs.

With the existing mechanisms, the support for low latency applications has a rather binary character. In particular, the mechanisms to ensure that a latency requirement is met may adversely affect other applications of the same STA or the traffic of other STAs. This may happen even if the latency requirements of the low latency applications are not that critical and would in principle allow to achieve acceptable service quality for both the low latency applications and other applications. Further, when multiple low latency applications require timely transmissions, there may be a need to efficiently manage such concurrent demands of low latency applications.

Accordingly, there is a need for techniques which allow for efficiently managing wireless communication associated with low latency applications or services.

### SUMMARY

According to an embodiment, a method of controlling wireless transmissions in a wireless communication system is provided. According to the method, a wireless communication device sends a first wireless transmission during ongoing communication of data in the wireless communication system. The first wireless transmission indicates a change of a need to communicate data subject to a latency requirement and comprises information on the data to be communicated. In response to sending the first wireless transmission, the wireless communication device communicates the data subject to the latency requirement in a second wireless transmission.

According to a further embodiment, a method of controlling wireless transmissions in a wireless communication system is provided. According to the method, a wireless communication device receives a first wireless transmission from a further wireless communication device during ongoing communication of data in the wireless communication system. The first wireless transmission indicates a change of a need of the further wireless communication device to communicate data subject to a latency requirement and comprises information on the data to be communicated. Based on the first wireless transmission, the wireless communication device adapts communication of the data subject to the latency requirement in a second wireless transmission.

According to a further embodiment, a wireless communication device for a wireless communication system is provided. The wireless communication device is configured to send a first wireless transmission during ongoing communication of data in the wireless communication system. The first wireless transmission indicates a change of a need to communicate data subject to a latency requirement and comprises information on the data to be communicated. Further, the wireless communication device is configured to, in response to sending the first wireless transmission, communicates the data subject to the latency requirement in a second wireless transmission.

According to a further embodiment, a wireless communication device for a wireless communication system is provided. The wireless communication device comprises at least one processor and a memory. The memory contains instructions executable by said at least one processor, whereby the wireless communication device is operative to send a first wireless transmission during ongoing communication of data in the wireless communication system. The first wireless transmission indicates a change of a need to communicate data subject to a latency requirement and comprises information on the data to be communicated. Further, the memory contains instructions executable by said at least one processor, whereby the wireless communication device is operative to, in response to sending the first wireless transmission, communicate the data subject to the latency requirement in a second wireless transmission.

According to a further embodiment, a wireless communication device for a wireless communication system is provided. The wireless communication device is configured to receive a first wireless transmission from a further wireless communication device during ongoing communication of data in the wireless communication system. The first wireless transmission indicates a change of a need of the further wireless communication device to communicate data subject to a latency requirement and comprises information on the data to be communicated. Further, the wireless communication device is configured to, based on the first wireless transmission, adapt communication of the data subject to the latency requirement in a second wireless transmission.

According to a further embodiment, a wireless communication device for a wireless communication system is provided. The wireless communication device comprises at least one processor and a memory. The memory contains instructions executable by said at least one processor, whereby the wireless communication device is operative to receive a first wireless transmission from a further wireless communication device during ongoing communication of data in the wireless communication system. The first wireless transmission indicates a change of a need of the further wireless communication device to communicate data subject to a latency requirement and comprises information on the data to be communicated. Further, the memory contains instructions executable by said at least one processor, whereby the wireless communication device is operative to, based on the first wireless transmission, adapt communication of the data subject to the latency requirement in a second wireless transmission.

According to a further embodiment, a computer program or computer program product is provided, e.g., in the form of a non-transitory storage medium, which comprises program code to be executed by at least one processor of a wireless communication device. Execution of the program code causes the wireless communication device to send a first wireless transmission during ongoing communication of data in the wireless communication system. The first wireless transmission indicates a change of a need to communicate data subject to a latency requirement and comprises information on the data to be communicated. Further, execution of the program code causes the wireless communication device to, in response to sending the first wireless transmission, communicates the data subject to the latency requirement in a second wireless transmission.

According to a further embodiment, a computer program or computer program product is provided, e.g., in the form of a non-transitory storage medium, which comprises program code to be executed by at least one processor of a wireless communication device. Execution of the program code causes the wireless communication device to receive a first wireless transmission from a further wireless communication device during ongoing communication of data in the wireless communication system. The first wireless transmission indicates a change of a need of the further wireless communication device to communicate data subject to a latency requirement and comprises information on the data to be communicated. Further, execution of the program code causes the wireless communication device to, based on the first wireless transmission, adapt communication of the data subject to the latency requirement in a second wireless transmission.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates an example of an indication frame according to an embodiment.

FIG. 3 illustrates an example of processes for wireless communication of low latency traffic according to an embodiment.

FIG. 4 illustrates a further example of processes for wireless communication of low latency traffic according to an embodiment.

FIG. 5 illustrates a further example of processes for wireless communication of low latency traffic according to an embodiment.

FIG. 6 illustrates a further example of processes for wireless communication of low latency traffic according to an embodiment.

FIG. 7 illustrates a further example of processes for wireless communication of low latency traffic according to an embodiment.

FIG. 8 illustrates a further example of processes for wireless communication of low latency traffic according to an embodiment.

FIG. 9 illustrates a further example of processes for wireless communication of low latency traffic according to an embodiment.

FIG. 10 illustrates a further example of processes for wireless communication of low latency traffic according to an embodiment.

FIG. 11 illustrates a further example of processes for wireless communication of low latency traffic according to an embodiment.

FIG. 12 shows a flowchart for schematically illustrating a method according to an embodiment.

FIG. 13 shows a flowchart for schematically illustrating a further method according to an embodiment.

FIG. 14 schematically illustrates structures of a wireless communication device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3rd Generation Partnership Project).

In the illustrated concepts, wireless communication devices may indicate during ongoing communication of data whether there is a change of a need to communicate data subject to a latency requirement. For this purpose, a first wireless communication device, e.g., a non-AP STA or an AP, may send a first wireless transmission with an indication of the change to a second wireless communication device, which may be an AP or a non-AP STA. Accordingly, the indication could be sent from a non-AP STA to an AP, from an AP to another AP, from a non-AP STA to another non-AP STA, or from an AP to a non-AP STA. The indication is in the following also denoted as low latency service announcement (LLSA) message. The LLSA allows the wireless communication devices to share information on their needs to send or receive the data subject to the latency requirement. More specifically, the LLSA message may be used to signal whether the data subject to the latency requirement needs to be sent and/or changes concerning the latency requirement itself. For example, the LLSA message may indicate when a low latency service starts, when a low latency service stops, or when the traffic load is about to reach a critical limit so that there is a risk that the latency requirement can no longer be fulfilled with the current resource allocation. Further, the LLSA message may carry further traffic specific information. This information may be useful as different wireless transmissions may have different requirements concerning latency or reliability. As these requirements and/or conditions which affect fulfilment of such requirements may change during the ongoing communication, the LLSA message may allow for efficiently adapting the wireless transmissions to such changes. The LLSA message may be configured as a small-size message which can be transmitted in a resource efficient manner and without being affected by uncontrollable delays. For example, the LLSA message may have a size which is sufficiently small to allow transmission of the LLSA message in a TXOP (transmit opportunity) gap or to send it as an overlaid transmission using the same resources as other wireless transmissions.

In some scenarios, a non-AP STA and an AP to which the non-AP STA is associated may need to communicate data of a low-latency service. In such scenario, the non-AP STA could send the LLSA message to the AP, thereby enabling the AP to make an informed decision on whether there is a need to stop or otherwise limit other wireless transmissions in order to serve a wireless transmission with data of the low-latency service, or if there is possibility for the AP to serve the wireless transmission concurrently with other wireless transmissions, while still fulfilling the requirements imposed on all wireless transmissions. The other wireless transmissions may include wireless transmissions to or from the non-AP STA, however related to another service or application. Alternatively or in addition, the other wireless transmissions may include wireless transmissions to or from one or more other non-AP STAs associated with the AP. In a similar manner, the non-AP STA could react to a LLSA message from the AP, by deciding based on the LLSA message whether there is a need to stop or otherwise limit other wireless transmissions in order to serve a wireless transmission with data of the low-latency service, or if there is possibility for the non-AP to serve the wireless transmission concurrently with other wireless transmissions, e.g., related to another service or application. Accordingly, in some scenarios the LLSA message may inform its recipient that the existing situation allows for handling the latency requirement in a more relaxed manner, so that one or more other wireless transmissions could be handled in addition, while still meeting the latency requirement.

In some scenarios, the wireless communication device which receives the LLSA message may send a response, in the following denoted as LLSA response. The LLSA response may for example confirm that the low-latency service can be provided while fulfilling the existing requirements, or whether more relaxed requirements are needed. Additionally, the LLSA response could indicate resources that will be used for the upcoming wireless transmission(s) of data of the low-latency service. In some scenarios, the two wireless communication devices may use the LLSA message and the LLSA response to agree on the resources for be used for a wireless transmission carrying the data subject to the latency requirement.

In the illustrated concepts, when an AP receives the LLSA message from an associated non-AP STA, the AP may reallocate resources based on the information provided in the LLSA message so that the resources can be used for other wireless transmissions to or from the AP, while still meeting the requirements of the low-latency service. Accordingly, the AP may dynamically adapt to changes of the traffic underlying the low-latency service, such as temporary pausing of the traffic or a reduction of other concurrent traffic. As a result, the AP may be able to maintain other connections in a way that would not be feasible if the AP had allocated all available resources to the low-latency device.

Moreover, the illustrated concepts may also allow for efficiently handling applications or services that are subject to a latency requirement and require higher data rates, such as an augmented reality (AR) application, a virtual reality (VR) application, an automated guided vehicle (AGV) application or an remote-controlled robot application. Because such applications or services need more resources over a longer period of time, the additional information provided by the LLSA messages from the non-AP STAs can be highly valuable for the AP to accurately assess how to allocate the available resources among multiple coexisting services and applications, of which at least some may be low-latency services. As a result, a satisfactory QoS (Quality of Service) level may be provided for multiple coexisting applications or services and for multiple non-AP STAs. Further, the information provided in the LLSA messages may allow for long-term optimization of QoS satisfaction.

In scenarios where the LLSA message is transmitted from the AP to one or more non-AP STAs, the non-AP STA(s) may for example use the information provided in the received LLSA message to decide on reservation of resources for incoming wireless transmissions including the data subject to the latency requirements.

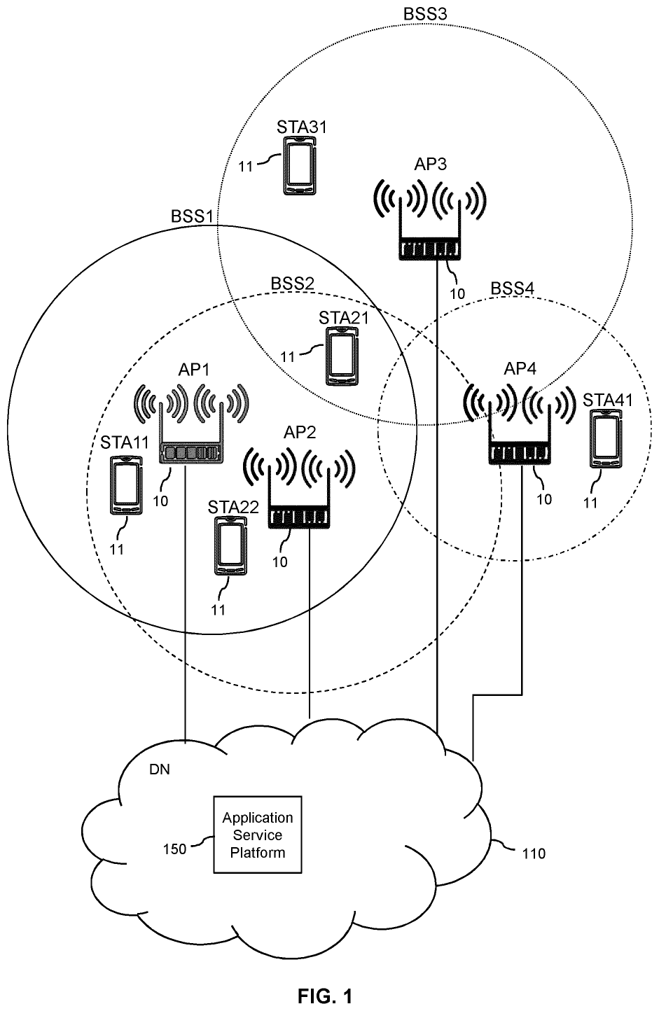

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA21, STA22, STA31, and STA41. STA11 is served by AP1, in a first BSS (Basic Service Set) denoted as BSS1. STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like. In some scenarios, one or more of the APs 10 and/or one or more of the stations 11 may correspond to MLDs (Multi-Link Devices).

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt frequency band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the illustrated concepts, DL (downlink) wireless transmissions from an AP 10 to its associated station 11 and/or UL (uplink) wireless transmissions from the station 11 to its associated AP 10 may be used for carrying data of a service or application that is subject to a latency requirement, e.g., a low latency service like for example an IloT application, an AR application, a VR application, a AGV application, or a remote-controlled robot application. In such scenarios, the station 11 may send an LLSA message to its associated AP 10 to inform the AP 10 about a change of the need to communicate the data subject to the low-latency requirement. Similarly, the AP 10 may send an LLSA message to its associated station 11 to inform the station 11 about a change of the need to communicate the data of the low-latency service. The change may for example be due to temporarily pausing or resuming of the communication of the data or to temporary pausing or resuming of other data communication, or to some other change of conditions. Based on the information provided in the LLSA message from the station 11 to the AP 10, the AP 10 can take more informed decisions concerning which of its associated stations 11 and/or which services should be prioritized or can be served concurrently on the available resources. Based on the LLSA message received from the AP 10, the station(s) 11 can assess whether to stop or otherwise limit certain wireless transmissions, e.g., carrying data of other services, or if it is possible to split the available resources between the concurrent services while still being able to meet the latency requirement.

The LLSA message may be signaled in advance, before an intended wireless transmission carrying the data of the low-latency service, to make sure that the AP 10 or station 11 receiving the LLSA message is aware of the data to be transmitted and its associated requirements and reacts accordingly, e.g., by pre-booking resources. Alternatively, the LLSA message could be sent as an immediate emergency notification indicating that the resources currently allocated or reserved for the low-latency service are no longer sufficient to meet the latency requirement or some other QoS requirement.

As mentioned above, the AP 10 or station 11 receiving the LLSA message may react by sending an LLSA response. The LLSA response may acknowledge reception of the LLSA message. Further, the LLSA response may indicate additional information to the sender of the LLSA message. For example, the LLSA response may indicate whether latency requirement can still be fulfilled with the change indicated by the LLSA message. Further, the LLSA response could indicate that the low-latency service can still be provided, however under less strict requirements. Further, the LLSA response may indicate additional information. For example, an LLSA response from the AP 10 to the station 11 could indicate a rate of trigger frames for triggering UL wireless transmissions from the station 11 or a rate of DL wireless transmissions from the AP 10. Further, an LLSA response from the AP 10 to the station 11 may indicate one or more transmit parameters that the station 11 can tune to improve the performance of UL wireless transmissions.

It is noted that in some cases the LLSA message may also be used to indicate that its sender, at least temporarily, does not have a need to communicate data subject to a latency requirement, e.g., when pausing or otherwise suspending the low-latency service. The recipient of the LLSA message may consider this information when allocating or reallocating the available resources, so that overall operation in the BSS may be optimized.

As mentioned above, the LLSA message may be subject to a size limitation, so that it can be efficiently used in the context of wireless transmissions requiring a high data rate and/or longer transmit durations. To achieve this, the LLSA message may need to be significantly smaller than a message carrying the actual data of the low-latency service. The content of the LLSA message may thus be limited to information like: an identifier of the type of the data, e.g., a traffic identifier (TID), an application identifier (AID), an SCS (Stream Classification Service) identifier, or the like; an indicator whether the LLSA message relates to UL, DL, or both; a level of urgency; or an indication of resource requirements. The level of urgency and resource requirements can be signaled in several different ways depending on the size requirement of the message. The level of urgency could for example be signaled by a number from a certain range where, for example, a low number indicates low urgency and a high number indicates a high urgency. Alternatively the level of urgency could be indicated in terms of a maximum delay limit. The maximum delay limit may correspond to a delay value above which the low-latency service is deemed to cease proper function. The resource requirements may be indicated by one or more of: a target average bitrate, a target maximum bitrate, a maximum delay tolerance of the service, a time/frequency need for the next transmission, a queue size, or any combination of these elements.

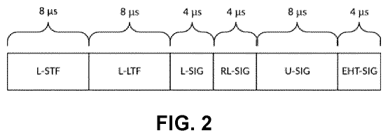

In some scenarios, the LLSA message may be conveyed using a frame format without payload section, e.g., a Null Data Packet (NDP) consisting only of a preamble, similar to that as specified in the EHT technology for sounding purposes. FIG. 2 schematically illustrates an example of a corresponding frame format.

In the example of FIG. 2, the frame format includes the following elements as specified in the EHT draft: L-STF, L-LTF, L-SIG, RL-SIG, U-SIG, and EHT-SIG. The U-SIG field may be used to indicate whether the LLSA message is transmitted to a non-AP STA, i.e., to a user, or to an AP. For example, a certain bit of the U-SIG field may be set to 1 to indicate transmission to a user. Setting the bit to 0 may indicate transmission to the AP. Alternatively, another bit of the U-SIG field could be set to one to indicate transmission to the AP. The above-mentioned information carried by the LLSA message may be included in the EHT-SIG field. According to Section 35.10.1.1 of the EHT draft, the EHT-SIG field shall contain the 11 LSB (Least Significant Bits) of the STA identity (STA_ID) of the non-AP STA transmitting the PPDU (Physical Packet Data Unit). This may be used as the ID field for the LLSA message. Bit B15 of the EHT-SIG field may be used to indicate that the frame is an EHT-NDP LLSA frame. For example, setting B15 to 0 can indicate that the PPDU corresponds to an NDP LLSA message. It is however noted that other choices of signaling such information are possible as well. For example, bits of the EHT-SIG field could encode a value pointing to one of multiple types of NDP frame, to indicate that the frame corresponds to an NDP LLSA message.

It is noted that conveying the LLSA message using a NDP frame format is merely one example and that other frame formats could be used as well, e.g., a control frame.

As indicated above, the LLSA message may be applied in various use cases. In the following, examples of such use cases will be explained in more detail.

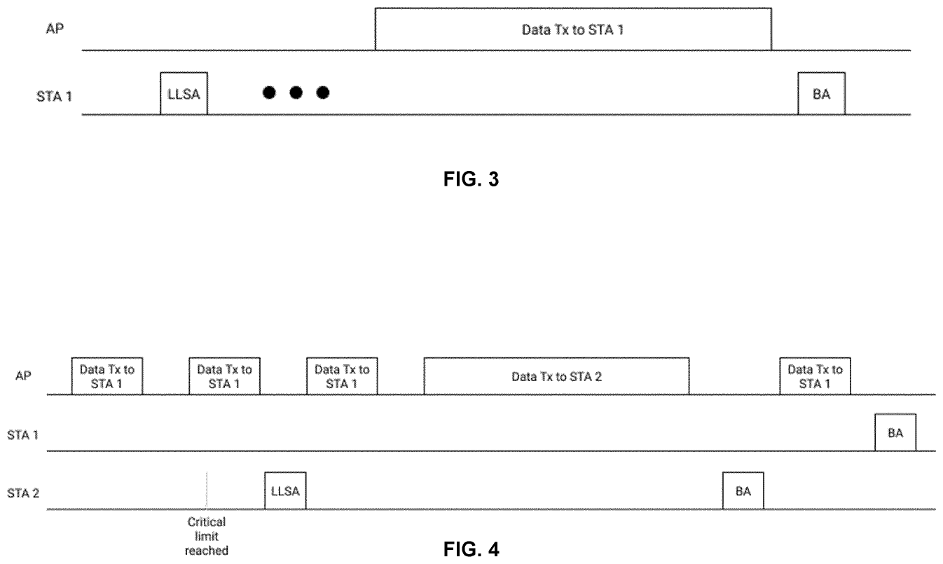

FIG. 3 illustrates an example of processes for wireless communication of low latency traffic in a use case in which the LLSA message is used to signal some QoS requirements in advance for long term consideration. The example of FIG. 3 involves an AP and a non-AP STA associated with the AP, denoted as STA1. The AP and the non-AP STA of FIG. 3 may correspond to an AP 10 and associated station 11 as illustrated in FIG. 1. As illustrated, at some time STA1 sends the LLSA message, which is received by the AP. The LLSA message indicates a change of the need of STA1 to communicate data of a low-latency service, e.g., by indicating that the latency requirement can be handled in a more relaxed manner. Based on the information included in the LLSA message, the AP can adapt a future transmission of the data of the low-latency service to STA1 (as indicated by “Data Tx to STA1”). STA1 receives the data and acknowledges successful reception of the data by sending a Block Acknowledgement (BA) to the AP.

FIG. 4 illustrates an example of processes for wireless communication of low latency traffic in a use case in which the LLSA message is used to signal an urgent change of the need to communicate data of a low-latency service. The example of FIG. 4 involves an AP and non-AP STAs associated with the AP, denoted as STA1 and STA2. The AP and the non-AP STAs of FIG. 4 may correspond to an AP 10 and associated stations 11 as illustrated in FIG. 1. In the example of FIG. 4, the AP initially sends multiple wireless transmissions of data to STA1 (as indicated by “Data Tx to STA1”). The data sent to STA1 may for example correspond to some application or service that is not subject to a particular latency requirement, in the following also denoted as non-critical data. The AP sends the data to STA1 in TXOPs reserved on the channel. At some point in time, STA2 detects that a critical limit for a low-latency service hosted by STA2 is reached and that more resources are needed to fulfil the latency requirement. STA2 indicates this change by sending an LLSA message to the AP. As illustrated, STA2 sends the LLSA message in a TXOP gap between two of the TXOPs used for the transmissions of the data to STA1. Accordingly, the LLSA message can be sent quickly and adverse effects on the transmissions to STA1 can be avoided. The LLSA message indicates the change of the need of STA2 to communicate data of a low-latency service, e.g., by indicating stricter resource requirements. Based on the information included in the LLSA message, the AP can adapt a future transmission of the data of the low-latency service to STA2 (as indicated by “Data Tx to STA2”). This may also involve reallocating resources from STA1 to STA2. STA2 receives the data and acknowledges successful reception of the data by sending a BA to the AP. After sending the data to STA2, the AP may continue with one more further transmissions of data to STA1. As illustrated, also STA1 acknowledges successful reception of the data by sending a BA to the AP.

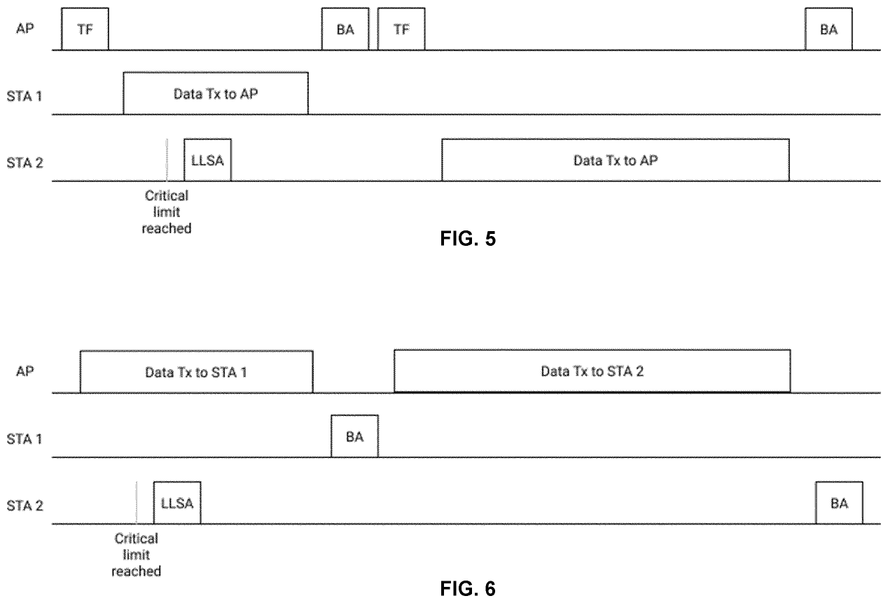

FIG. 5 illustrates a further example of processes for wireless communication of low latency traffic in a use case in which the LLSA message is used to signal an urgent change of the need to communicate data of a low-latency service. The example of FIG. 5 involves an AP and non-AP STAs associated with the AP, denoted as STA1 and STA2. The AP and the non-AP STAs of FIG. 5 may correspond to an AP 10 and associated stations 11 as illustrated in FIG. 1. In the example of FIG. 5, STA1 initially sends a wireless transmission of data to the AP (as indicated by “Data Tx to AP”). The transmission of the data from STA1 to the AP is triggered by a trigger frame (TF) from the AP. The data sent from STA1 to the AP may for example correspond to some application or service that is not subject to a particular latency requirement. At some point in time, during the transmission of the data from STA1 to the AP, STA2 detects that a critical limit for a low-latency service hosted by STA2 is reached and that more resources are needed to fulfil the latency requirement. STA2 indicates this change by sending an LLSA message to the AP. As illustrated, STA2 sends the LLSA message by overlaying it to the transmission of the data from STA1 to the AP. Accordingly, the LLSA message can be sent immediately. By using overlaying of the LLSA message to the ongoing transmission of the data from STA1, adverse effects on the transmission from STA1 can be avoided. The LLSA message indicates the change of the need of STA2 to communicate data of a low-latency service, e.g., by indicating stricter resource requirements. Based on the information included in the LLSA message, the AP can adapt a future transmission of the data of the low-latency service from STA2 to the AP (as indicated by “Data Tx to AP”). In the illustrated example, this involves scheduling STA2 for the next transmission and, accordingly, sending a TF to STA2 to trigger the transmission from STA2 to the AP. As further illustrated, the AP receives the data from STA1 and from STA2 and acknowledges successful reception of the data by sending a corresponding BA to STA1 and a corresponding BA to STA2.

FIG. 6 illustrates a further example of processes for wireless communication of low latency traffic in a use case in which the LLSA message is used to signal an urgent change of the need to communicate data of a low-latency service. The example of FIG. 6 involves an AP and non-AP STAs associated with the AP, denoted as STA1 and STA2. The AP and the non-AP STAS of FIG. 6 may correspond to an AP 10 and associated stations 11 as illustrated in FIG. 1. In the example of FIG. 6, the AP initially sends a wireless transmission of data to STA1 (as indicated by “Data Tx to STA1”). The data sent from the AP to STA1 may for example correspond to some application or service that is not subject to a particular latency requirement. At some point in time, during the transmission of the data from the AP to STA1, STA2 detects that a critical limit for a low-latency service hosted by STA2 is reached and that more resources are needed to fulfil the latency requirement. STA2 indicates this change by sending an LLSA message to the AP. As illustrated, STA2 sends the LLSA message by overlaying it to the transmission of the data from the AP to STA1. Accordingly, the LLSA message can be sent immediately. Concurrently sending the transmission of the data to STA1 and reception of the LLSA message from STA2 may be efficiently enabled by utilizing a full-duplex capability of the AP. Adverse effects on the transmission to STA1 can be avoided. The LLSA message indicates the change of the need of STA2 to communicate data of a low-latency service, e.g., by indicating stricter resource requirements. Based on the information included in the LLSA message, the AP can adapt a future transmission of the data of the low-latency service to STA2 (as indicated by “Data Tx to STA2”). In the illustrated example, this involves scheduling STA2 for the next transmission. As further illustrated, STA1 and STA2 receive the data from the AP and acknowledge successful reception of the data by each sending a BA to the AP.

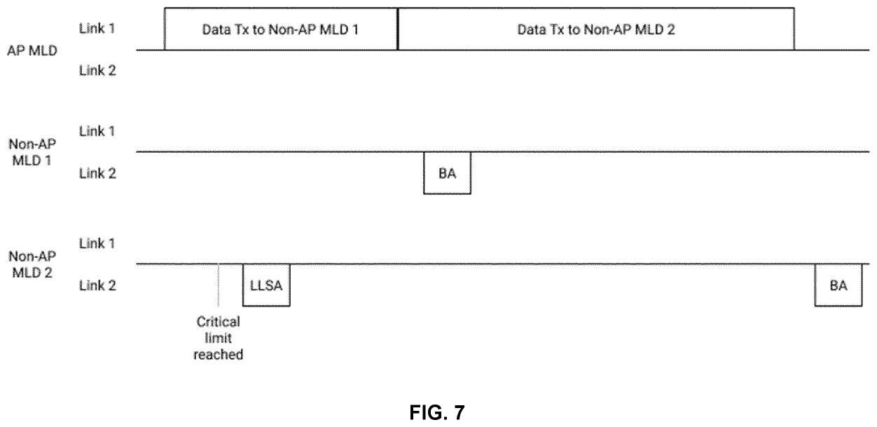

FIG. 7 illustrates a further example of processes for wireless communication of low latency traffic in a use case in which the LLSA message is used to signal an urgent change of the need to communicate data of a low-latency service. The example of FIG. 7 involves an AP MLD and non-AP MLDs associated with the AP, denoted as Non-AP MLD 1 and Non-AP MLD 2. The AP MLD and the non-AP MLDs of FIG. 7 may correspond to an AP 10 and associated stations 11 as illustrated in FIG. 1. The AP MLD and the non-AP MLDs operate on two separate links, denoted as Link 1 and Link 2. These links may for example correspond to different frequency channels from the same or different frequency bands. In the example of FIG. 7, the AP MLD initially sends a wireless transmission of data on Link 1 to Non-AP MLD1 (as indicated by “Data Tx to Non-AP MLD 1”). The data sent from the AP MLD to Non-AP MLD 1 may for example correspond to some application or service that is not subject to a particular latency requirement. At some point in time, during the transmission of the data from the AP MLD to Non-AP MLD 1, Non-AP MLD 2 detects that a critical limit for a low-latency service hosted by Non-AP MLD 2 is reached and that more resources are needed to fulfil the latency requirement. Non-AP MLD 2 indicates this change by sending an LLSA message to the AP MLD. As illustrated, Non-AP MLD 2 sends the LLSA message on Link 2. Accordingly, the LLSA message can be sent immediately, without adverse effects on the transmission of data from the AP MLD to Non-AP MLD 1. The LLSA message indicates the change of the need of Non-AP MLD 2 to communicate data of a low-latency service, e.g., by indicating stricter resource requirements. Based on the information included in the LLSA message, the AP MLD can adapt a future transmission of the data from the AP to Non-AP MLD 2 (as indicated by “Data Tx to Non-AP MLD 2”). In the illustrated example, this involves scheduling Non-AP MLD 2 for the next transmission on Link 1. As further illustrated, the Non-AP MLD 1 and Non-AP MLD 2 receive the data from the AP and acknowledge successful reception of the data by each sending a BA to the AP. These BAs are sent on Link 2. As can be seen, in scenarios involving

MLDs, the ML capable devices can utilize the multiple available links to separate control signaling from the transmissions of data, so that the LLSA can be sent on another link than the data.

When the AP (which may also be an AP MLD like in the example of FIG. 7) has received an LLSA message indicating some level of urgency for an application it may decide how to react taking into account the information provided by the LLSA message. For example, the AP may decide to refrain from adapting future communication and continue with the current way of scheduling wireless transmissions to or from its associated stations. The AP may choose this option when it expects that the latency requirement for the low-latency service can still be met without adaptation. According to another option, the AP may decide to adapt its future scheduling decisions for wireless transmissions to or from its associated stations, e.g., by prioritizing scheduling of the wireless transmissions related to the low-latency service of the sender of the LLSA message. Further, the AP could decide to preempt an ongoing wireless transmission in favor of immediately starting a wireless transmission related to the low-latency service of the sender of the LLSA message. Further, the AP could decide to use multi-AP (MAP) coordination with one or more neighboring APs to achieve more efficient resource usage so that more resources can be allocated to the wireless transmissions related to the low-latency service of the sender of the LLSA message. In some scenarios, the AP could also send an LLSA response to the sender of the LLSA message. Such LLSA response may include a positive acknowledgement or negative acknowledgement to the sender of the LLSA message, indicating whether the AP has accepted or rejected the indicated change, e.g., by indicating whether the sender of the LLSA message can expect more resources for future communication of the data of the low-latency service. Further, the LLSA response may include a renegotiation message informing the sender of the LLSA message that the AP cannot support the indicated requirements and indicating a proposal of requirements that could be supported. Such renegotiation may for example be useful in the case of an AR service or VR service that may change the video resolution to enable continuing the service. In some cases, the AP could also decide to abandon the low-latency service, e.g., if the requirements of the low-latency service cannot be met or if another service is deemed to have higher priority.

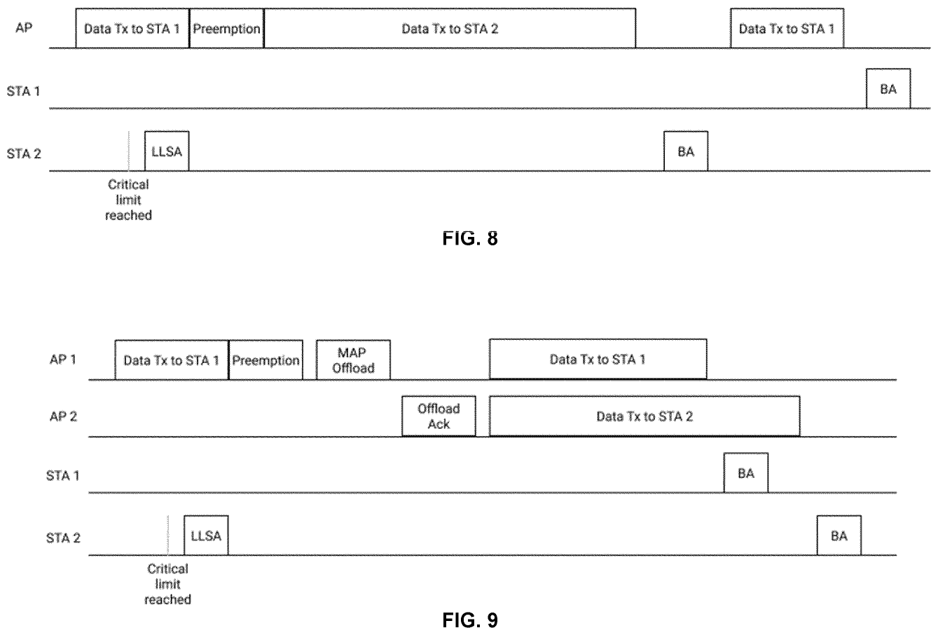

FIG. 8 illustrates an example of processes for wireless communication of low latency traffic in a scenario in which the AP reacts to the LLSA message by preempting an ongoing transmission. The example of FIG. 8 involves an AP and non-AP STAs associated with the AP, denoted as STA1 and STA2. The AP and the non-AP STAs of FIG. 8 may correspond to an AP 10 and associated stations 11 as illustrated in FIG. 1. In the example of FIG. 8, the AP initially sends a wireless transmission of data to STA1 (as indicated by “Data Tx to STA1”). The data sent from the AP to STA1 may for example correspond to some application or service that is not subject to a particular latency requirement. At some point in time, during the transmission of the data from the AP to STA1, STA2 detects that a critical limit for a low-latency service hosted by STA2 is reached and that more resources are needed to fulfil the latency requirement. STA2 indicates this change by sending an LLSA message to the AP. As illustrated, STA2 sends the LLSA message by overlaying it to the transmission of the data from the AP to STA1, similar to the scenario of FIG. 6. The LLSA message indicates the change of the need of STA2 to communicate data of a low-latency service, e.g., by indicating stricter resource requirements. Based on the information included in the LLSA message, the AP decides to preempt the ongoing transmission to STA1 and immediately start a transmission of the data of the low-latency service to STA2 (as indicated by “Data Tx to STA2”). As further illustrated, STA2 receives the data from the AP and acknowledges successful reception of the data by sending a BA to the AP. As further illustrated, the AP may then continue with the transmission of data to STA1, and STA1 may then acknowledge successful reception of the data by sending a BA to the AP.

FIG. 9 illustrates an example of processes for wireless communication of low latency traffic in a scenario in which the AP reacts to the LLSA message by preempting an ongoing transmission and initiating MAP coordination with another AP. The example of FIG. 9 involves two APs, denoted as AP1 and AP2, and non-AP STAs associated with AP1, denoted as STA1 and STA2. The APs and the non-AP STAs of FIG. 9 may correspond to APs 10 and stations 11 as illustrated in FIG. 1. In the example of FIG. 9, AP1 initially sends a wireless transmission of data to STA1 (as indicated by “Data Tx to STA1”). The data sent from AP1 to STA1 may for example correspond to some application or service that is not subject to a particular latency requirement. At some point in time, during the transmission of the data from AP1 to STA1, STA2 detects that a critical limit for a low-latency service hosted by STA2 is reached and that more resources are needed to fulfil the latency requirement. STA2 indicates this change by sending an LLSA message to AP1. As illustrated, STA2 sends the LLSA message by overlaying it to the transmission of the data from AP1 to STA1, similar to the scenario of FIG. 6. The LLSA message indicates the change of the need of STA2 to communicate data of a low-latency service, e.g., by indicating stricter resource requirements. Based on the information included in the LLSA message, AP1 decides to preempt the ongoing transmission to STA1 and initiate MAP coordination with AP2. In the illustrated example, the MAP coordination involves that AP1 sends a MAP Offload request to AP2, requesting that some traffic of the BSS of AP1 can be offloaded to AP2, which is accepted by AP2 and confirmed by sending a MAP Offload Acknowledgement from AP2 to AP1. In the illustrated example, the offloaded traffic is the data traffic with STA2. Accordingly, AP2 then starts a transmission of the data of the low-latency service to STA2 (as indicated by “Data Tx to STA2”), while AP1 continues with the transmission of the data to STA1. As further illustrated, STA1 receives the data from AP1 and acknowledges successful reception of the data by sending a BA to AP1. Further, STA2 receives the data from AP2 and acknowledges successful reception of the data by sending a BA to AP2.

As can be seen from the examples of FIGS. 3 to 9, the LLSA can be sent in an efficient manner during ongoing communication of data in a BSS. In the example of FIG. 3, the ongoing communication of data involves the sender of the LLSA. In the examples of FIGS. 4 to 9, the ongoing communication is between other devices than the sender of the LLSA, namely between another STA and the AP to which the sender of the LLSA is associated.

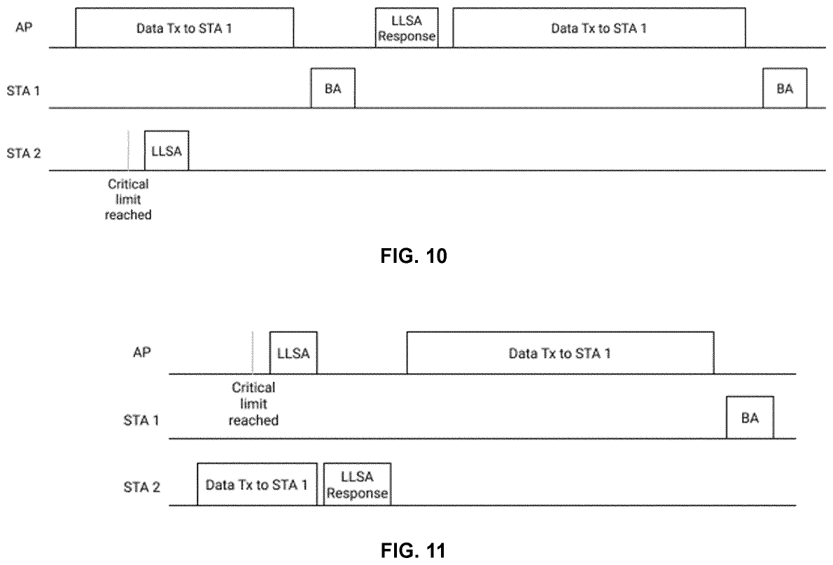

FIG. 10 illustrates an example of processes for wireless communication of low latency traffic in a scenario in which the AP reacts to the LLSA message by sending an LLSA response. The example of FIG. 10 involves an AP and non-AP STAs associated with the AP, denoted as STA1 and STA2. The AP and the non-AP STAs of FIG. 10 may correspond to an AP 10 and associated stations 11 as illustrated in FIG. 1. In the example of FIG. 10, the AP initially sends a wireless transmission of data to STA1 (as indicated by “Data Tx to STA1”). The data sent from the AP to STA1 may for example correspond to a first low latency service. At some point in time, during the transmission of the data from the AP to STA1, STA2 detects that a critical limit for a second low-latency service hosted by STA2 is reached and that more resources are needed to fulfil the latency requirement. STA2 indicates this change by sending an LLSA message to the AP. As illustrated, STA2 sends the LLSA message by overlaying it to the transmission of the data from the AP to STA1, similar to the scenario of FIG. 6. The LLSA message indicates the change of the need of STA2 to communicate data of the second low-latency service, e.g., by indicating stricter resource requirements. Based on the information included in the LLSA message, the AP decides to first finish the ongoing transmission to STA1 and then, after receiving a BA indicating successful reception of the data by STA1, send an LLSA response to STA2. The LLSA response rejects the change of the requirements indicated by the LLSA message, e.g., because the first low-latency service of STA1 is deemed to be more urgent. The AP may then continue with a further transmission of data to STA1, and STA1 may then acknowledge successful reception of the further data by sending a BA to the AP.

The LLSA response may however indicate some alternative requirements that could be supported for STA2.

FIG. 11 illustrates an example of processes for wireless communication of low latency traffic in a scenario in which a non-AP STA reacts to an LLSA message from an AP. The example of

FIG. 11 involves an AP and non-AP STAs associated with the AP, denoted as STA1 and STA2. The AP and the non-AP STAs of FIG. 10 may correspond to an AP 10 and associated stations 11 as illustrated in FIG. 1. In the example of FIG. 11, the STA2 initially sends a wireless transmission of data to STA1 (as indicated by “Data Tx to STA1”). The data sent from the STA2 to STA1 may for example be based on a TDLS (Tunneled Direct Link Setup) communication mode, which does not involve the AP. At some point in time, during the transmission of the data from the STA2 to STA1, the AP detects that a critical limit for a low-latency service requiring transmission of DL data to STA1 is reached and that more resources are needed to fulfil the latency requirement. The AP indicates this change by sending an LLSA message to STA1 and STA2. As illustrated, the AP sends the LLSA message by overlaying it to the transmission of the data from the STA2 to STA1. The LLSA message indicates the change of the need of the AP to communicate data of the low-latency service. The DL data may include urgent DL data from the AP and/or may request urgent UL data from STA1. Based on the information included in the LLSA message, the STA2 decides to interrupt or terminate the ongoing transmission to STA1 and then send an LLSA response to the AP. The LLSA response accepts the change of the requirements indicated by the LLSA message. Based on the LLSA response, the AP knows the medium is now available and then starts sending the DL data of the low-latency service to STA1, as indicated by “Data Tx to STA1”. STA1 may then acknowledge successful reception of the DL data by sending a BA to the AP.

In view of the above, interaction of an LLSA sender, which may be a non-AP STA or an AP, and an LLSA recipient, which may be an AP or a non-AP STA, may be as follows: the LLSA sender detects that traffic conditions of traffic subject to a latency requirement at the LLSA sender have changed, e.g., that some critical limit for latency sensitive traffic of the LLSA sender was reached. In response, the LLSA sender checks if there is an opportunity to transmit an LLSA message, in particular if the channel is available for sending the LLSA message. If there is such opportunity, the LLSA sender sends the LLSA message. If there is no such opportunity, the LLSA sender waits until there is an opportunity to send the LLSA and then sends the LLSA message.

The LLSA recipient receives the LLSA message and then checks based on the information from the LLSA message whether the urgency indicated by the LLSA message is sufficiently high to initiate an immediate reaction by the LLSA recipient. If this is not the case, the LLSA recipient may handle the traffic of the LLSA sender without further adaptation, e.g., by scheduling the traffic based on previously existing information. If the urgency level is sufficiently high, the LLSA recipient continues by checking if the resources needed to meet the change indicated by the LLSA message can be provided without changing the handling of the traffic of other services or devices, e.g., by reducing the priority of such other traffic as compared to the traffic indicated by the LLSA message. If this is the case, the LLSA recipient sends an LLSA response to the LLSA sender, indicating that the change indicated by the LLSA message is accepted and that the service can be further supported with the required QoS level.

If the resources needed to meet the change indicated by the LLSA message cannot be provided without changing the handling of the traffic of other services or devices, the LLSA recipient continues by checking if the service to which the LLSA message relates has a higher priority than other services handled by the LLSA recipient, e.g., other services handled for the LLSA sender or other services of other devices. If this is the case, the LLSA recipient continues with checking if the service to which the LLSA message relates can be further handled by the LLSA recipient. If this is the case, the LLSA recipient continues with checking if the service(s) of lower priority need to be interrupted immediately. If this is not the case, the LLSA recipient may continue scheduling the traffic using updated parameters, so that the LLSA sender can continue normal operation of the service. Otherwise, the LLSA recipient may preempt one or more ongoing transmissions of other services, so that the LLSA sender can continue normal operation of the service. If the LLSA recipient determines that the service to which the LLSA message relates cannot be further handled by the LLSA recipient, the LLSA recipient offloads the traffic of the service to another AP, using MAP coordination, so that the LLSA sender can continue normal operation of the service.

If the service to which the LLSA message relates does not have higher priority than another service handled by the LLSA recipient, the LLSA recipient continues by checking if some resources of the other service(s) can be reallocated to the service to which the LLSA message relates. If this is the case, the LLSA recipient continues by sending an LLSA response to the LLSA sender, indicating alternative supported traffic parameters. Based on the LLSA response, the LLSA sender may then check if the alternative supported traffic parameters are sufficient to keep operation of the service at reduced rate. If this is the case, the LLSA sender continues with operation of the service at reduced rate. If this is not the case, the LLSA sender triggers a QoS failure for the service. If some resources of the other service(s) cannot be reallocated to the service to which the LLSA message relates, the LLSA recipient checks if there is a need to report this assessment to the LLSA sender. If this is the case, the LLSA recipient sends an LLSA response to the LLSA sender, indicating that the change indicated by the LLSA message is rejected, and the LLSA sender then triggers a QoS failure for the service. If there is no need to report the assessment to the LLSA sender, the LLSA recipient may locally abandon the service. In response, the LLSA sender detects a timeout for the service and triggers a QoS failure for the service.

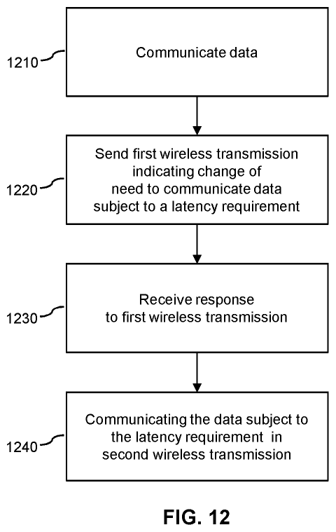

FIG. 12 shows a flowchart for illustrating a method of controlling wireless transmissions in a wireless communication system, which may be utilized for implementing the illustrated concepts. The method of FIG. 12 may be used for implementing the illustrated concepts in a wireless communication device operating in a wireless communication system, e.g., one of the above-mentioned stations 11 or APs 10. The wireless communication system may be based on a wireless local area network, WLAN, technology, e.g., according to the IEEE 802.11 standards family.

If a processor-based implementation of the wireless communication device is used, at least some of the steps of the method of FIG. 12 may be performed and/or controlled by one or more processors of the wireless communication device. Such wireless communication device may also include a memory storing program code for implementing at least some of the below described functionalities or steps of the method of FIG. 12.

At step 1210, the wireless communication device may communicates data. The communicated data may or may not be subject to a latency requirement.

At step 1220, during ongoing communication of data in the wireless communication system, the wireless communication device sends a first wireless transmission indicating a change of a need to communicate data subject to a latency requirement and comprises information on the data to be communicated. The first wireless transmission may correspond to the above-mentioned LLSA message. The information on the data to be communicated may include an identifier of traffic type, e.g., in terms of a TID, AID, or SCS identifier, an indication whether the data is to be communicated from the wireless communication device or to be communicated to the wireless communication device, e.g., by indicating whether the data is UL data or DL data, an indication of a level of urgency of communicating the data, and/or an indication of resources requested for communicating the data. The ongoing communication of data may include communication of data between other wireless communication devices, e.g., like in the examples of FIGS. 4 to 11. However, the ongoing communication of data could alternatively or additionally include communication of data to or from the wireless communication device itself, e.g., like in the example of FIG. 3. The latter example of ongoing communication of data may for example include the data optionally communicated at step 1210.

The first wireless transmission may be adapted to allow overlaying of the first wireless transmission on one or more other wireless transmissions. Alternatively or in addition, the first wireless transmission may be adapted to fit into time gaps between other wireless transmissions, e.g., into a TXOP gap. Alternatively or in addition, the first wireless transmission may be adapted to fit into frequency gaps left unoccupied by one or other wireless transmissions. The first wireless transmission may be based on a frame structure consisting only of a preamble portion, e.g., as illustrated in FIG. 2.

If the wireless communication device is a non-AP STA, it may send the first wireless transmission to an AP, e.g., to the AP to which it is associated, or to another non-AP STA. If the wireless communication device is an AP, it may send the first wireless transmission to a further AP or to a non-AP STA.

At step 1230, the wireless communication device may receive a response to the first wireless communication. The response may correspond to the above-mentioned LLSA response, the second wireless transmission may then be based on the response. The response may acknowledge that the latency requirement can be met. Alternatively, the response could indicate that the latency requirement cannot be met. Further, the response could indicate resources for the second wireless transmission or one or more parameters to be used for the second wireless transmission. Still further, the response could indicate one or more parameters to be used for further wireless transmission from the wireless communication device.

At step 1240, in response to sending the first wireless transmission, the wireless communication device communicates the data subject to the latency requirement in a second wireless transmission. In some cases, the communication of the data subject to the latency requirement may involve that the second wireless transmission is adapted in accordance with the information indicated in the first wireless transmission. The adaptation may for example concern scheduling of the second wireless transmission or resource requirements for the second wireless transmission.

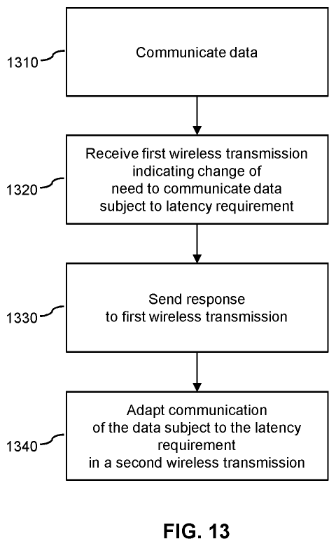

FIG. 13 shows a flowchart for illustrating a method of controlling wireless transmissions in a wireless communication system, which may be utilized for implementing the illustrated concepts. The method of FIG. 13 may be used for implementing the illustrated concepts in a wireless communication device operating in a wireless communication system, e.g., one of the above-mentioned stations 11 or APs 10. The wireless communication system may be based on a wireless local area network, WLAN, technology, e.g., according to the IEEE 802.11 standards family.

If a processor-based implementation of the wireless communication device is used, at least some of the steps of the method of FIG. 13 may be performed and/or controlled by one or more processors of the wireless communication device. Such wireless communication device may also include a memory storing program code for implementing at least some of the below described functionalities or steps of the method of FIG. 13.

At step 1310, the wireless communication device may communicate data subject to a latency requirement. The data communicated at step 1210 may or may not be subject to a latency requirement.

At step 1320, during ongoing communication of data subject in the wireless communication system, the wireless communication device receives a first wireless transmission from a further wireless communication device. The first wireless transmission indicates a change of a need of the further wireless communication device to communicate data subject to a latency requirement and comprises information on the data to be communicated. The first wireless transmission may correspond to the above-mentioned LLSA message. The information on the data to be communicated may include an identifier of traffic type, e.g., in terms of a TID, AID, or SCS identifier, an indication whether the data is to be communicated from the wireless communication device or to be communicated to the wireless communication device, e.g., by indicating whether the data is UL data or DL data, an indication of a level of urgency of communicating the data, and/or an indication of resources requested for communicating the data. The ongoing communication of data may include communication of data between the wireless communication device and another wireless communication device, e.g., like in the examples of FIGS. 4 to 11. However, the ongoing communication of data could alternatively or additionally include communication of data to or from the further wireless communication device itself, e.g., like in the example of FIG. 3. The latter example of ongoing communication of data may for example include the data optionally communicated at step 1310.

The first wireless transmission may be adapted to allow overlaying of the first wireless transmission on one or more other wireless transmissions. Alternatively or in addition, the first wireless transmission may be adapted to fit into time gaps between other wireless transmissions, e.g., into a TXOP gap. Alternatively or in addition, the first wireless transmission may be adapted to fit into frequency gaps left unoccupied by one or other wireless transmissions. The first wireless transmission may be based on a frame structure consisting only of a preamble portion, e.g., as illustrated in FIG. 2.

If the wireless communication device is an AP, the further wireless communication device may be a non-AP STA, e.g., an associated non-AP STA, or another AP. If the wireless communication device is a non-AP STA, the further wireless communication device may be another non-AP STA or an AP, e.g., the AP to which it is associated.

At step 1330, the wireless communication device may send a response to the first wireless communication. The response may correspond to the above-mentioned LLSA response, the second wireless transmission may then be based on the response. The response may acknowledge that the latency requirement can be met. Alternatively, the response could indicate that the latency requirement cannot be met. Further, the response could indicate resources for the second wireless transmission or one or more parameters to be used for the second wireless transmission. Still further, the response could indicate one or more parameters to be used for further wireless transmission from the wireless communication device.

At step 1340, the wireless communication device adapts communication of the data subject to the latency requirement in a second wireless transmission. The adaptation of step 1340 is based on the first wireless transmission received at step 1320. The adaptation may for example concern scheduling of the second wireless transmission, resource allocation for the second wireless transmission, or resource requirements for the second wireless transmission.

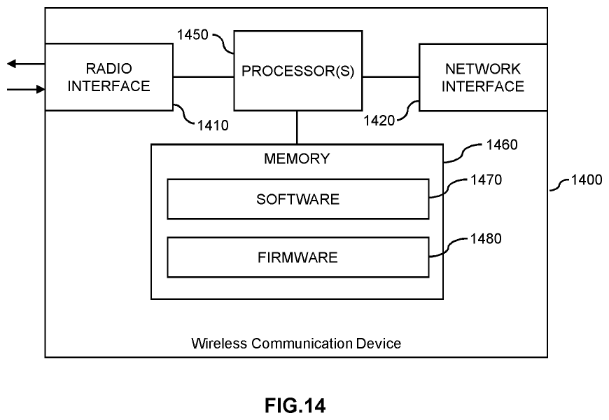

FIG. 14 illustrates a processor-based implementation of a wireless communication device 1400. The structures as illustrated in FIG. 14 may be used for implementing the above-described concepts. The wireless communication device 1400 may for example correspond to a non-AP STA or to an AP, e.g., one of above-mentioned stations 11 or APs 10.

As illustrated, the wireless communication device 1400 includes a radio interface 1410. The radio interface 1410 may for example be based on a WLAN technology, e.g., according to an IEEE 802.11 family standard. However, other wireless technologies could be supported as well, e.g., the LTE technology or the NR technology. Further, if the wireless communication device 1400 corresponds to an AP, the wireless communication device 1400 may be provided with a network interface 1420 for connecting to a data network, e.g., using a wire-based connection.

Further, the wireless communication device 1400 may include one or more processors 1450 coupled to the interfaces 1410, 1420, and a memory 1460 coupled to the processor(s) 1450. By way of example, the interface(s) 1410, 1420, the processor(s) 1450, and the memory 1460 could be coupled by one or more internal bus systems of the wireless communication device 1400. The memory 1460 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1460 may include software 1470 and/or firmware 1480. The memory 1460 may include suitably configured program code to be executed by the processor(s) 1450 so as to implement the above-described functionalities for controlling wireless transmissions, such as explained in connection with the method of FIG. 12 and/or in connection with the method of FIG. 13.

It is to be understood that the structures as illustrated in FIG. 14 are merely schematic and that the wireless communication device 1400 may actually include further components which, for the sake of clarity, have not been illustrated, e.g., further interfaces or further processors. Also, it is to be understood that the memory 1460 may include further program code for implementing known functionalities of an AP in an IEEE 802.11 technology. According to some embodiments, also a computer program may be provided for implementing functionalities of the wireless communication device 1400, e.g., in the form of a physical medium storing the program code and/or other data to be stored in the memory 1460 or by making the program code available for download or by streaming.

As can be seen, the concepts as described above may be used for efficiently managing wireless transmissions of data subject to a latency requirement, specifically by considering the possibility that the actual need to communicate such data may vary in a dynamic manner. In this way, the wireless transmissions of data subject to a latency requirement may also be efficiently coordinated with other wireless transmissions, so that multiple services can be better served on the same resources.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be also be applied with respect to various kinds of services or applications. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1.-52. (canceled)

53. A method of controlling wireless transmissions in a wireless communication system, the method performed by a wireless communication device and comprising:
during ongoing communication of data in the wireless communication system, sending a first wireless transmission indicating a change of a need to communicate data that is subject to a latency requirement, wherein the first wireless transmission comprises information about the data subject to the latency requirement; and
in response to sending the first wireless transmission, communicating the data subject to the latency requirement in a second wireless transmission.

54. The method of claim 53,wherein the information about the data subject to the latency requirement comprises one or more of the following:
a traffic type identifier for the data;
an indication whether the data is to be communicated from the wireless communication device or to be communicated to the wireless communication device;
an indication of an urgency level for communicating the data; and
an indication of resources requested for communicating the data.

55. The method of claim 53, wherein the first wireless transmission is adapted according to one or more of the following:
to allow overlaying of the first wireless transmission on one or more other wireless transmissions;
to fit into time gaps between the other wireless transmissions; and
to fit into frequency gaps left unoccupied by the other wireless transmissions.

56. The method of claim 53, wherein the first wireless transmission is based on a frame structure consisting only of a preamble portion.

57. The method of claim 53, further comprising receiving a response to the first wireless transmission, wherein the response includes or indicates one or more of the following:
that the latency requirement can or cannot be met;
resources for the second wireless transmission;
one or more parameters to be used for the second wireless transmission; and
one or more parameters to be used for further wireless transmission from the wireless communication device.

58. The method of claim 53, wherein the wireless communication device is a non-access point station and sends the first wireless transmission to one of the following: an access point station, or a further non-access point station.

59. The method of claim 53, wherein the wireless communication device is an access point station and sends the first wireless transmission to one of the following: a further access point station, or a non-access point station.

60. A method of controlling wireless transmissions in a wireless communication system, the method performed by a wireless communication device and comprising:
during ongoing communication of data in the wireless communication system, receiving a first wireless transmission from a further wireless communication device,
wherein:
the first wireless transmission indicates a change of a need for the further wireless communication device to communicate data subject to a latency requirement, and
the first wireless transmission comprises information about the data subject to the latency requirement; and
based on the first wireless transmission, adapting communication of the data subject to the latency requirement in a second wireless transmission.

61. The method of claim 60, wherein adapting communication of the data subject to the latency requirement in a second wireless transmission comprises one or more of the following: reallocation of communication resources, stopping one or more other wireless transmissions, and. prioritizing the second wireless transmission over the other wireless transmissions.

62. The method of claim 60, wherein the information about the data subject to the latency requirement comprises one or more of the following:
a traffic type identifier for the data;
an indication whether the data is to be communicated from the wireless communication device or to be communicated to the wireless communication device;
an indication of an urgency level for communicating the data; and
an indication of resources requested for communicating the data.

63. The method of claim 60, wherein the first wireless transmission is adapted according to one or more of the following:
to allow overlaying of the first wireless transmission on one or more other wireless transmissions;
to fit into time gaps between the other wireless transmissions; and
to fit into frequency gaps left unoccupied by the other wireless transmissions.

64. The method of claim 60, wherein the first wireless transmission is based on a frame structure consisting only of a preamble portion

65. The method of claim 60, further comprising sending a response to the first wireless transmission, wherein the response includes or indicates one or more of the following:
that the latency requirement can or cannot be met;
resources for the second wireless transmission;
one or more parameters to be used for the second wireless transmission; and
one or more parameters to be used for further wireless transmission from the wireless communication device.

66. The method of claim 60, wherein the wireless communication device is an access point station and the further wireless communication device is one of the following: a non-access point station, and a further access point station.

67. The method of claim 60, wherein the wireless communication device is a non-access point station and the further wireless communication device is one of the following: an access point station, or a further non-access point station.

68. A wireless communication device configured for operation in a wireless communication system, the wireless communication device comprising:
at least one processor, and
a memory containing program code executable by the at least one processor, wherein execution of the program code by the at least one processor causes the wireless communication device to:
during ongoing communication of data in the wireless communication system, send a first wireless transmission indicating a change of a need to communicate data that is subject to a latency requirement, wherein the first wireless transmission comprises information about the data subject to the latency requirement; and
in response to sending the first wireless transmission, communicate the data subject to the latency requirement in a second wireless transmission.

69. The wireless communication device of claim 68, wherein the information about the data subject to the latency requirement comprises one or more of the following:
a traffic type identifier for the data;
an indication whether the data is to be communicated from the wireless communication device or to be communicated to the wireless communication device;
an indication of an urgency level for communicating the data; and
an indication of resources requested for communicating the data.

70. The wireless communication device of claim 68, wherein execution of the program code by the at least one processor further causes the wireless communication device to receive a response to the first wireless transmission, wherein the response includes or indicates one or more of the following:
that the latency requirement can or cannot be met;
resources for the second wireless transmission;
one or more parameters to be used for the second wireless transmission; and
one or more parameters to be used for further wireless transmission from the wireless communication device.

71. A wireless communication device configured for operation in a wireless communication system, the wireless communication device comprising:
at least one processor, and
a memory containing program code executable by the at least one processor, wherein execution of the program code by the at least one processor causes the wireless communication device to:
during ongoing communication of data in the wireless communication system, receive a first wireless transmission from a further wireless communication device, wherein:
the first wireless transmission indicates a change of a need for the further wireless communication device to communicate data subject to a latency requirement, and
the first wireless transmission comprises information about the data subject to the latency requirement; and
based on the first wireless transmission, adapt communication of the data subject to the latency requirement in a second wireless transmission.

72. The wireless communication device of claim 71, wherein the information about the data subject to the latency requirement comprises one or more of the following:
a traffic type identifier for the data;
an indication whether the data is to be communicated from the wireless communication device or to be communicated to the wireless communication device;
an indication of an urgency level for communicating the data; and
an indication of resources requested for communicating the data.
